(19) United States
(12) Patent Application Publication
(10) Pub. No.: US 2023/0242847 A1
(43) Pub. Date: Aug. 3, 2023

(54) DISSOLVABLE MONO-DOSE CLEANING PACKETS AND METHOD FOR PRINTING ON SAME

(71) Applicant: Dune Sciences, Inc., Eugene, OR (US)

(72) Inventors: John M. Miller, Eugene, OR (US); David WALLA, Eugene, OR (US); Richard GEIGER, Eugene, OR (US)

(73) Assignee: Dune Sciences, Inc., Eugene, OR (US)

(21) Appl. No.: 18/101,930

(22) Filed: Jan. 26, 2023

Related U.S. Application Data
(60) Provisional application No. 63/304,799, filed on Jan. 31, 2022.

(51) Int. Cl. C11D 17/04; C11D 11/00; C11D 3/00; C11D 3/48; C11D 3/50; C11D 3/40; C11D 3/22

(52) U.S. Cl. CPC C11D 17/044; C11D 17/043; C11D 11/0017; C11D 3/0021; C11D 3/0036; C11D 3/0068; C11D 3/48; C11D 3/50; C11D 3/40; C11D 3/225

(57) ABSTRACT

A single-load cleaning packet and method of use are provided for laundry and other applications. The cleaning packet in accordance with the present disclosure comprises a paper material that is sealed to form a pouch, and a detergent sealed within the pouch. In embodiments, the paper material is at least partially dissolvable in water to release the detergent included in the pouch. The cleaning packet further comprises a printed message or graphic on the paper material, wherein an ink of the printed message or graphic includes an active ingredient beneficial for wash. In one example, the active ingredient of the ink may include an anti-microbial or anti-odor compound. The incorporation of the active ingredient into the printing ink allows it to be physically separated from the detergent contained within the pouch, thereby aiding in a staggered release during wash.

### CROSS-REFERENCE TO RELATED APPLICATIONS

The present application claims priority to U.S. Provisional Patent Application No. 63/304,799, filed Jan. 31, 2022, the contents of which are incorporated by reference herein in their entirety.

### TECHNICAL FIELD

The present disclosure relates to dissolvable single-load detergent packets for laundry and other applications.

### BACKGROUND

More recently, detergent products have been commercially available in a form that provide a single dose of detergent for a consumer to add directly to the cleaning operation. Consumers like the convenience of single dose laundry products and appreciate protection from chemical exposure. A single dose detergent packet or pouch generally comprises a pre-measured detergent composition encapsulated in a water-soluble film, such as polyvinyl alcohol (PVA). Traditionally, some PVA detergent packets are also configured to be multi-chambered allowing physical separation of chemical ingredients of the detergent composition to prevent their interactions or to stagger their release. However, the manufacture of PVA is energy and resource intensive. Additionally, because of the shape, coloring, and resemblance with candy, children may be attracted to the multi-chambered PVA detergent packets very easily. This has previously led to accidental ingestions and death. Furthermore, the PVA detergent packets sometimes do not dissolve well and can leave residue on clothes, resulting in damage to the clothes or the need for rewashing.

### BRIEF DESCRIPTION OF THE DRAWINGS

Embodiments will be readily understood by the following detailed description in conjunction with the accompanying drawings and the appended claims.

Embodiments are illustrated by way of example and not by way of limitation in the figures of the accompanying drawings.

FIG. 1 illustrates a front view of a cleaning packet according to the present disclosure;

FIGS. 2A-2C illustrate example embodiments of the cleaning packet of FIG. 1 with a message or graphic printed using an ink with an active ingredient;

FIG. 3 illustrates a back view of the cleaning packet of FIG. 1 in accordance with the present disclosure;

FIG. 4 illustrates a side view of the cleaning packet of FIG. 1 in accordance with the present disclosure;

FIG. 5 illustrates a flow chart of an example method for producing the cleaning packet of FIG. 1 in accordance with the present disclosure; and

FIG. 6 illustrates a flow chart of an example method for using the cleaning packet of FIG. 1, in a washing machine environment, in accordance with the present disclosure.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order-dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Embodiments herein may resolve one or more of the above-described issues related to single dose PVA-based multi-chambered detergent packets and their energy and resource intensive manufacture. Specifically, embodiments relate to systems, articles of manufacture, and techniques for use of a cleaning packet, for example for laundry and other applications. The cleaning packet, according to at least one embodiment of the present disclosure, may include a paper material that is sealed to form a pouch. A detergent composition may be sealed within the pouch. The paper material may be at least partially dissolvable in water to release the detergent included in the pouch. In embodiments, the cleaning packet of the present disclosure may further include a message or graphic printed on a printable region of the paper material, wherein an ink used to print the message or graphic may comprise an active ingredient dissolvable in water and beneficial for the laundry cycle.

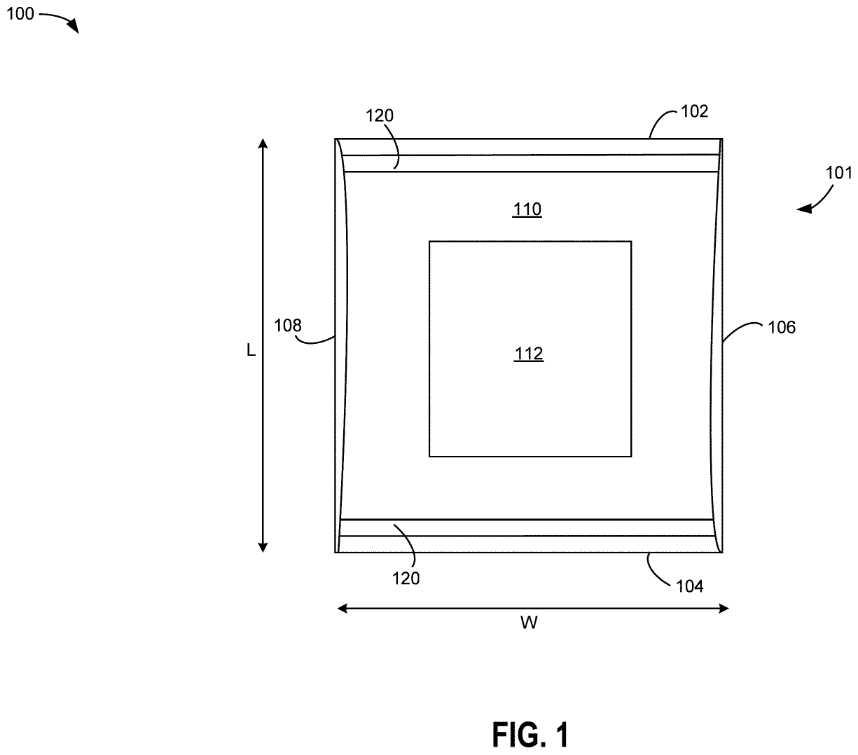

FIG. 1 depicts a front view 100 of a cleaning packet 101, according to the present disclosure. The cleaning packet 101 may include a pouch 110 and a detergent composition (not shown) sealed within the pouch 110. The cleaning packet 101 may be configured to be made of a water-soluble material such that it at least partially dissolves or disintegrates upon contact with a liquid, thereby releasing or discharging the detergent composition into the liquid.

The material of the cleaning packet 101 may include a paper material, for example paper that is not treated with a wet strength agent, or paper with other ingredients that may enable the cleaning packet 101 to at least partially disintegrate and release the contents of the pouch 110 into water as desired. The water-soluble material of the cleaning packet 101 may include cellulose, lignin, hemicellulose, carboxymethyl cellulose, methylcellulose, gums, starches and starch derivatives, gelatin and/or any combination of these. In some examples, at least a portion of the cleaning packet 101 may be configured to be opaque, while in other examples, at least a portion of the cleaning packet 101 may be configured to be transparent or translucent. The the cleaning packet 101, according to the present disclosure, is configured to be durable, and in embodiments may be able to withstand freezing. Additionally, the cleaning packet 101 of the present disclosure is configured to dissolve and release the detergent composition quickly, especially in cold water (such as temperatures from approximately 60 to approximately 80 degrees Fahrenheit). The carboxymethyl cellulose of the cleaning packet 101 may act as a dye absorbing and anti-redeposition agent during wash. As used herein, anti-redeposition may refer to an agent that limits the ability of a substance to redeposit onto clothes during or after the washing process. Thus, the paper-based pouch of the present disclosure is safe, convenient to use, biodegradable, and non-toxic.

It will be understood that, although the material of the cleaning packet 101 is described as water-soluble, in other embodiments only a portion of the cleaning packet 101 may be water-soluble. For example, in some embodiments the pouch 110 may be formed of a water-soluble material, while another portion of the cleaning packet 101 (e.g., a portion of the cleaning packet that is adjacent to the pouch 110 such as the below-described seals) may not be water-soluble.

Alternatively, in some embodiments the material of the pouch 110 may not be water-soluble, and instead only a portion of the cleaning packet 101 such as one of the below-described seals may at least partially dissolve in water, as described in greater detail below. In this manner, the cleaning packet 101 may open upon contact of the cleaning packet 101 with water, and allow for dispersion of the detergent composition from the pouch 110. The opened cleaning packet 101 may then be retrieved, refilled, and re-sealed, thereby further increasing reusability of the cleaning packet 101.

The cleaning packet 101 may be of any suitable shape and construction and is preferably configured to include a flexible pouch 110 such that the cleaning packet 101 may at least slightly bend during contact or movement without breaking. The most convenient shapes, from the viewpoints of both manufacture and packing, are square and rectangular; however, some other desired shape may be used in other embodiments. In the illustrated example, the cleaning packet 101 has a shape of a rectangle with a top edge 102, a bottom edge 104, a first side edge 106, and a second side edge 108. The first side edge 106 and the second side edge 108 may have a length L, while the top edge 102 and the bottom edge 104 may have a width W. The cleaning packet 101 may be of various sizes. Accordingly, the length L and the width W of the cleaning packet 101 may vary. In one example, the cleaning packet 101 may be a 2.5 inches by 2.5 inches square with at least three of the various edges 102/104/106/108 being sealed to prohibit leakage of the detergent from the pouch 110. In other examples, the cleaning packet 101 may be configured as a stick-pack with a plurality of pouches 110 having a size of 3 inches by 1 inch with a fin seal (e.g., a seal that runs along a generally central portion of a face of the cleaning packet 101). Other alternative embodiments may use various other sizes, without departing from the scope of this disclosure.

The cleaning packet 101 may be formed of one or more sheets of paper or a tubular section of the sheet material. In some examples, the cleaning packet 101 may be made of a single folded sheet and sealed on three sides to form the pouch 110, while in other examples, two sheets of the material may be bonded together at the edges with a water-soluble sealing material to form the pouch 110. Alternatively, in yet other examples, the sheets may be folded like envelopes with overlapping flaps to be sealed. This envelope-like form of construction may be beneficial in that it tends to be stronger than the edge seals. The pouch 110 may also be reinforced to decrease the risk of leakage during handling. For example, an extra thickness of the sheet material may be added where the cleaning packet 101 is expected to be held or passing completely around the pouch 110 to help support the weight of detergent.

Sealing the pouch 110 may be done by any suitable method, for example heat-sealing, solvent-sealing, ultrasound sealing, cold pressure sealing, etc. In the illustrated example, a seal 120 is shown in each of a top portion and a bottom portion of the cleaning packet 101. Alternatively, water-sensitive seals in the cleaning packet 101 may be formed by using a water-soluble adhesive at one or more edges of the cleaning packet 101 (e.g., the top edge 102 and the bottom edge 104 of the pouch 110, in the illustrated example). Suitable water-soluble adhesives can, for example, be based on polysaccharides such as starch or dextrin, synthetic polymers such as polyvinyl alcohol, or alkali metal silicates.

If desired, a cleaning packet 101 may be formed with one pouch 110, or more than one pouch for different detergent ingredients. In some embodiments that include a plurality of pouches 110, the pouches may be formed in a conjoined manner, for example in a strip, to facilitate dosing of different numbers or types of detergent ingredients as appropriate for the wash conditions. The use of a multi-pouch cleaning packet 101 may facilitate the use of detergent ingredients that interact with other ingredients in detergent compositions, while avoiding encapsulation or other treatment to prevent contact between such ingredients in a single composition.

The detergent composition contained within the pouch 110 may be a water-reactive fabric-cleaning ingredient such as sodium carbonate, C12-15 Pareth-2, and sodium metasilicate, which may, in embodiments, be free from any fillers, perfumes, coloring agents, or brighteners. In some examples, the detergent composition may contain an oxygen-liberating bleaching agent, for example sodium perborate or sodium percarbonate. Other detergent compositions are also possible which may be packaged within the pouch 110, e.g., alkaline particulate detergent compositions that include a synthetic detergent compound, and a mixture of sodium tripolyphosphate and alkali metal orthophosphate. The detergent composition encapsulated in the pouch may be a highly concentrated powder or a mixture of powder and liquid.

A wide variety of detergent compositions may be used including compositions that have good cold water performance. As used herein, “cold water performance” may refer to how well the detergent composition works in “cold” water. “Cold” water may refer to water with a temperature that is between approximately 40 degrees Fahrenheit (° F.) and approximately 50° F. In some embodiments, “cold” water may refer to water that is between approximately 35° F. and approximately 55° F. In some embodiments, cold water performance may be based on effectiveness of stain removal during washing (e.g., whether there is visible loss of stain removal). In another embodiment, cold water performance may be based on how well the detergent composition dissolves in cold water. In some embodiments, such dissolution may be considered to be “good” if it dissolves with an efficiency that is at least equal to 1 milligram per milliliter (mg/mL). In some embodiments, a load size of detergent composition within the pouch 110 may vary as needed to achieve such cold water performance.

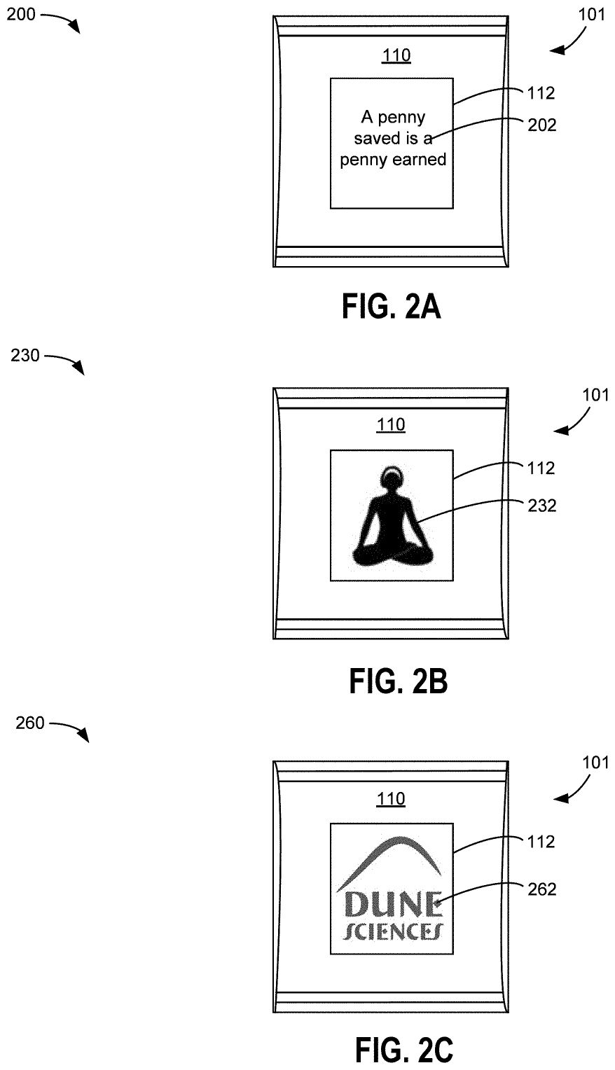

The cleaning packet 101, according to one embodiment, may further include a printable region 112 as shown in FIG. 1. The printable region 112 may be located, for example, on the pouch 110 or at some other location of the cleaning packet 101. In some embodiments, if multiple cleaning packets 101 are produced during manufacture (e.g., as a sheet of cleaning packets or strip of cleaning packets) and then later cut or otherwise separated, such a cut may occur at least partially within the printable region 112 such that the depicted graphic or message is split between two portions of the cleaning packet 101 (e.g., a part of the graphic at the top of the cleaning packet 101 and a part of the graphic at the bottom of the cleaning packet 101). The printable region 112 may include a message or graphics printed with an ink on the paper material of the cleaning packet 101. The printing ink in accordance with an embodiment of the present disclosure be, or may comprise, an active ingredient beneficial for one or more aspects of the laundry cycle. More details regarding the types of active ingredients of the ink and aspects of printing are provided below in FIGS. 2A-2C.

FIGS. 2A-2C depict three example embodiments of the cleaning packet 101 of FIG. 1 showing a message or graphic printed on the printable region 112 using an ink having an active ingredient. The components previously introduced are numbered similarly in these figures and are not re-introduced for brevity. FIGS. 2A-2C will be described herein collectively.

In FIG. 2A, a first example embodiment 200 of the cleaning packet 101 shows a message 202 printed on the printable region 112. In the illustrated example, the subject of the printed message 202 is an aphorism. In some examples, however, the subject of the printed message 202 may include affirmations, adages, proverbs, trivia, jokes, cleaning tips, instructions, and/or any combinations of these.

In FIG. 2B, a second example embodiment 230 of the cleaning packet 101 shows an image 232 printed on the printable region 112. In the illustrated example, the subject of the printed image 232 is a yoga pose. In some examples, however, the subject of the printed image 232 may include other yoga poses, pictures of animals or nature, scannable QR codes, or horoscope.

In FIG. 2C, a third example embodiment 260 of the cleaning packet 101 shows a brand logo 262 printed on the printable region 112. In the illustrated example, the printed brand logo 262 is of Dune Sciences. In some examples, the printable region 112 may include other distinctive ways of branding/marketing (e.g., printing sweepstakes for winning or golden tickets) with an intention to increase connection with the consumers and to showcase the brand's playfulness by making each cleaning packet unique.

In yet other examples, the printable region 112 may include messages to raise awareness of environmental issues or tips for reducing carbon footprint. Other subjects of the printing may be possible without departing from the scope of this disclosure.

The ink used to print messages (e.g., message 202 of FIG. 2A) or graphics (e.g., image 232 of FIG. 2B or logo 262 of FIG. 2C) may include a variety of materials or compounds as active ingredients that may be beneficial for a laundry cycle, according to the present disclosure. Some examples of the active ingredient of the ink may include a dye, fragrance, anti-microbial compound such as metallic nanoparticles, oxy-bleach catalyst, anti-odor compound, redeposition inhibitor, surfactant, and/or any combination of these. Additionally, ink that changes color after washing may also be used.

If desired, minor ingredients of the detergent compositions, for example fluorescent agents or anti-redeposition agents such as sodium carboxymethylcellulose, fabric-softening agents, heavy metal sequestrants such as EDTA, perfumes, and/or colorants or colored speckles may be embedded within the ink for addition to the wash liquor.

In the illustrated example, the ink of the printed message or graphics shown in FIGS. 2A-2C contains anti-odor and anti-microbial silver nanoparticles. The use of silver nanoparticles during laundry or wash may serve to reduce microbial growth in fabrics. In embodiments, nanoparticles may have a size (diameter) between approximately 1 and approximately 1000 nanometers. In some embodiments, the size of the nanoparticles may have a diameter between approximately 1 and approximately 100 nanometers. In some embodiments, the size of the nanoparticles may have a diameter between approximately 1 and approximately 10 nanometers. In other embodiments, other sizes may also be used. Nanoparticles are generally substantially spherical in shape, but, in various embodiments, one or more other shapes, such as rods, prisms, cubes, or wires are also possible.

A cleaning packet 101 with messages or graphics printed with an ink embedded with active ingredients not only increases brand awareness or creates a positive experience with a brand, but also provides a safe and convenient way to physically separate chemical ingredients of the detergent for an added functional benefit. Incorporation of some of the active ingredients into the ink of printed messages or graphics on the cleaning packet allows inclusion of multiple ingredients of the detergent without creating a multi-chambered detergent packet. Furthermore, it provides a novel form factor that allows customer acceptance of the use of less total weight per load of wash or laundry. Overall, this provides a convenient, safe, low dust, sustainable, bio-degradable, ecommerce friendly, and plastic free way to do laundry and other applications.

In some alternative embodiments, an active ingredient may not be printed on the cleaning packet 101 in the form of a message or graphics, but may be printed or applied as a transparent material on the front and/or back of the cleaning packet 101. In yet other embodiments, an active ingredient may be applied to the cleaning packet 101 without printing altogether on the pouch, but by incorporating a different colored paper, sticker, or fabric containing the active ingredient onto a structure of the cleaning packet 101 via weaving or water-soluble adhesives or via other methods. It is to be understood that these variations of the cleaning packet 101 are intended as non-limiting examples, and other embodiments may include further variations.

While the illustrated examples of the cleaning packet 101 in accordance with the present disclosure relate to laundry or fabric cleaning detergent packets, it is to be understood that the features of the cleaning packet 101 disclosed herein may also be applicable to dish washing cleaning packets 101 or various other types of detergent packets.

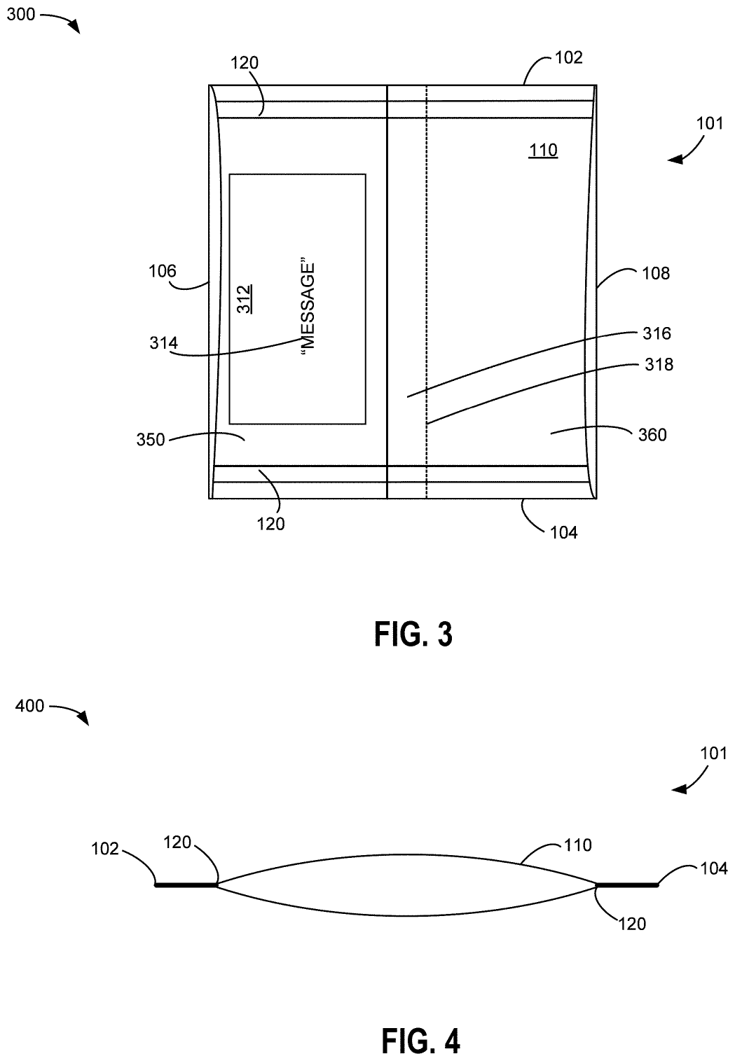

FIG. 3 depicts a back view 300 of the cleaning packet 101 of FIG. 1. As such, the components previously introduced are numbered similarly in this figure and are not re-introduced for brevity. As depicted in FIG. 3, the back view 300 of the cleaning packet 101 includes a second printable region 312 and a fin seal 316.

The fin seal 316 may include a fold-over seam 318 running longitudinally from the top edge 102 to the bottom edge 104 of the pouch 110. The fold-over seam 318 may be parallel to the first side edge 106 or the second side edge 108 of the cleaning packet 101. At the fold-over seam 318, both interior edges of a sheet of the pouch 110 may be sealed together and then the fin is folded over. As shown, the presence of the fin seal 316 divides the back of the pouch 110 equally into two regions, creating a first region 350 and a second region 360. In some examples, the fin seal 316 may be positioned such that the first region 350 and the second region 360 are created unequally, or the fin seal 316 is not parallel to one or both of the first edge 106 and second edge 108. While the illustrated example shows fin seal 316 on a back of the pouch 110 of the cleaning packet 101, other examples may include some other types of seals such as heat seal, solvent-seal, water-sensitive seal, and so on. In yet other examples, the sheet of the pouch 110 may be configured such that there are no seals on the back of the cleaning packet 101, but the seal may be present on a side of the cleaning packet 101.

The second printable region 312 may be located in either the first region 350 or the second region 360 or both. In examples where no seal is present on the back of the cleaning packet 101, the second printable region 312 may be located anywhere on the back of the cleaning packet 101. In other examples, however, the second printable region 312 may be omitted completely. As depicted, the second printable region 312 may include a message or graphics printed with an ink embedded with active ingredients beneficial for a laundry cycle, as described previously with reference to FIGS. 2A-2C. In the illustrated example, a message 314 is shown printed on the second printable region 312 with an ink containing fragrance. The subject of the printed message 314 may vary with various embodiments. In some examples, the second printable region 312 may be or include a graphic printed with an ink containing an anti-microbial compound, oxy-bleach catalyst, anti-odor compound, redeposition inhibitor, surfactant, and/or any combination of these. The types of active ingredient of the ink and the subject of the printing illustrated previously in FIGS. 2A-2C are also applicable to the second printable region 312 of FIG. 3.

FIG. 4 depicts a side view 400 of the cleaning packet 101 of FIG. 1. As such, the components previously introduced are numbered similarly in this figure and are not re-introduced for brevity. The side view 400 of the cleaning packet 101 exhibits the presence of a dome shape of the front and back of the pouch 110 due to the pouch 110 being filled with a detergent composition (not shown). Additionally, the top edge 102 and the bottom edge 104 of the pouch 110 are visible. Furthermore, the seals 120 on the top and bottom portions of the pouch 110 are shown in FIG. 4.

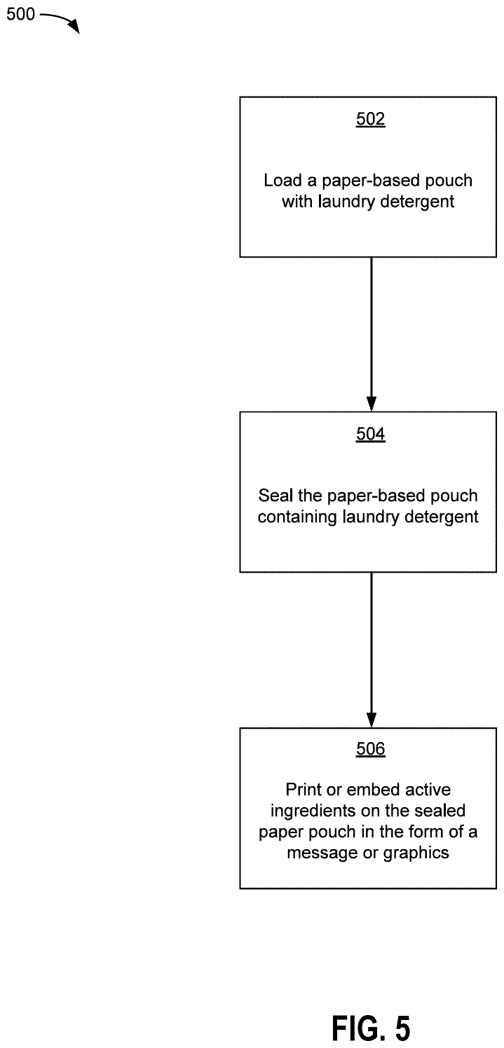

FIG. 5 provides the operations of an example method 500 for producing a cleaning packet, such as the cleaning packet 101 of FIG. 1. The operations of method 500 may be carried out in whole or in part to form the cleaning packet 101.

In operation 502, a paper-based pouch (e.g., pouch 110 of FIG. 1) is loaded with a detergent (e.g., laundry detergent). In some examples, the sheet of the paper-based pouch may be thermoformed into a dome shaped body and the detergent composition may be placed into the domed body of the pouch.

Following loading, in operation 504, the paper-based pouch containing the detergent composition is folded and sealed along all open edges. The pouch may be sealed by heat-sealing, solvent-sealing, ultrasound sealing, cold pressure sealing, or by using water-sensitive seals, as described previously with reference to FIG. 1. In examples where two sheets, e.g., a first sheet and a second sheet, are superimposed over each other to form the pouch, the first sheet and the second sheet may be sealed along a continuous region of the superimposed sheets surrounding the detergent composition to a form a base wall of the pouch.

In some embodiments, the paper-based pouch may be made on a form/fill machine (not shown), wherein the machine forms a flat paper stock into a pouch, fills it with a detergent composition and seals it to produce the final product. For example, the cleaning packet may be produced with a vertical or horizontal form fill and seal machine.

In operation 506, a message, graphics, brand logo, scannable QR codes and/or any combination of these may be printed on the front and/or back of the sealed paper pouch (or, in other embodiments, elsewhere on the surface of the cleaning packet 101) with an ink containing an active ingredient beneficial for wash/laundry. As described previously with reference to FIGS. 2A-2C, the active ingredient of the ink may include a dye, fragrance, anti-microbial compound such as metallic nanoparticles, oxy-bleach catalyst, anti-odor compound, redeposition inhibitor, surfactant, fabric-softening agents, heavy metal sequestrants, and/or any combination of these.

Thus, according to the method 500, the active ingredient of the printing ink is configured to be physically separated from the detergent composition contained within the paper pouch.

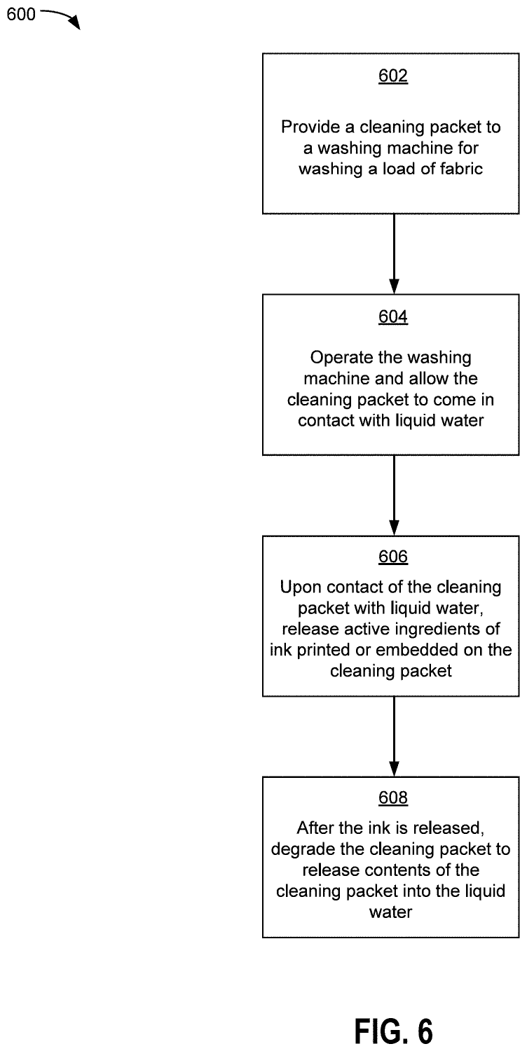

FIG. 6 provides the operations of an example method 600 for using a cleaning packet, such as the cleaning packet 101 of FIG. 1, to wash a load of fabric or garments in a washing machine. The operations of method 600 may be carried out in whole or in part using the cleaning packet 101.

In operation 602, the cleaning packet may be provided to the washing machine for washing the load of fabric contained within the washing machine. The cleaning packet includes a paper pouch with laundry detergent sealed therein, and a message or graphic printed on a back and/or front of the cleaning packet with an ink containing an active ingredient beneficial for wash.

In operation 604, the washing machine may be operated. As liquid water fills the washing machine containing the load of fabric during the operation, the cleaning packet comprising the laundry detergent is allowed to come in contact with the liquid water and the load of fabric to be washed.

In operation 606, upon contact of the cleaning packet with liquid water in the washing machine, the active ingredients of the ink of the message or graphics printed on the paper of the cleaning packet may start to release into the liquid water first.

Following the release of the ink of the cleaning packet into the liquid water, in operation 608, the paper of the cleaning packet degrades and at least partially dissolves in the liquid water. The degradation of the paper allows the contents (e.g., laundry detergent in the illustrated example) of the cleaning packet to be released into the liquid water such that the load of fabric or garments may be laundered.

Thus, according to the method 600, the release of the ink prior to the degradation of the cleaning packet allows the release of the active ingredients of the ink and the release of the laundry detergent to be staggered time wise, thereby utilizing the benefits of each component of the cleaning packet independently, thereby reducing concerns of the components interacting or reacting with each other. The release of the ink and the contents of the cleaning packet may be staggered such that the ink is completely released 30 seconds to 5 minutes, such as 30 seconds to 2 minutes, prior to the contents of the cleaning packet being released.

In embodiments, the ink may be released from 30 seconds to 10 minutes after the cleaning packet has been contacted with water.

In embodiments, the cleaning packet may degrade once in contact with water, and may release the contents contained therein from 30 seconds to 20 minutes after the cleaning packet has been contacted with water.

In accordance with embodiments herein, a paper-based cleaning packet reduces the cost and environmental footprint of single dose detergent manufacturing. A technical effect of incorporating an active ingredient into the ink of printed messages or graphics on the cleaning packet is that it allows physical separation of chemical ingredients without having the need for expensive and dangerous multi-chambered PVA detergent packets. Additionally, upon contact of the cleaning packet with water, a time of release of the active ingredients of the ink and a time of degradation of the cleaning packet may be staggered such that the advantages of each component of the cleaning packet may be utilized during wash without premature interaction. The cleaning packet, according to the present disclosure, is configured to dissolve/disperse better than PVA detergent packets, especially in cold water, while having an improved durability. An added benefit of having carboxymethylcellulose in the paper-based cleaning packet of the present disclosure is that it acts as a dye absorbing and anti-redeposition agent. Furthermore, the paper-based cleaning packet in accordance with the present disclosure is biodegradable, non-toxic, plastic-free and aesthetically pleasing without appearing to be edible. It also appeals to the sense of touch with a satisfying and smooth finish.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

The following claims particularly point out certain combinations and sub-combinations regarded as novel and nonobvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A cleaning packet comprising:
a paper material sealed to form a pouch; and
a detergent within the sealed pouch;
wherein the paper material is at least partially dissolvable in water to release the detergent sealed in the pouch.

2. The cleaning packet of claim 1, wherein the paper material is composed of cellulose, lignin, hemicellulose, or carboxymethylcellulose.

3. The cleaning packet of claim 2, wherein the carboxymethylcellulose of the paper material acts as a dye absorbing agent during fabric cleaning.

4. The cleaning packet of claim 2, wherein the carboxymethylcellulose of the paper material acts as an anti-redeposition agent during fabric cleaning.

5. The cleaning packet of claim 1, wherein the paper material is at least partially dissolvable in cold water.

6. The cleaning packet of claim 1, wherein the paper material is biodegradable, durable, and non-toxic.

7. The cleaning packet of claim 1, further comprising a printable region on the paper material.

8. The cleaning packet of claim 7, wherein the printable region of the paper material includes a message or graphic printed with an ink.

9. The cleaning packet of claim 8, wherein the ink of the printed message or graphic comprises an active ingredient dissolvable in water.

10. The cleaning packet of claim 9, wherein the active ingredient of the ink includes an anti-microbial or anti-odor compound such as metallic nanoparticles.

11. The cleaning packet of claim 9, wherein the active ingredient of the ink includes a dye or fragrance.

12. The cleaning packet of claim 9, wherein the active ingredient of the ink includes a surfactant or redeposition inhibitor.

13. The cleaning packet of claim 1, wherein the detergent is a laundry detergent for cleaning fabric, wherein the laundry detergent comprises a powder detergent or a mixture of liquid and powder detergents.

14. A method for producing a cleaning packet, comprising:
placing a detergent composition on a paper material;
sealing the paper material to form a pouch that contains the detergent composition; and
printing a message or graphic on a printable region of the paper material with an ink that includes an active ingredient;
wherein the active ingredient of the printing ink is physically separated from the detergent composition contained within the pouch.

15. The method of claim 14, wherein the cleaning packet is produced on a form/fill machine.

16. The method of claim 14, wherein the cleaning packet is heat sealed or sealed with an adhesive.

17. The method of claim 14, wherein the active ingredient of the printing ink is dissolvable in water, and wherein the active ingredient of the printing ink includes silver nanoparticles.

18. A cleaning packet comprising:
a water-dissolvable paper material that forms a sealed pouch with at least one sealed side;
a detergent composition positioned within the pouch; and
a message or graphic on an exterior portion of the pouch, wherein the message or graphic is printed with an ink that includes at least one water-reactive fabric-cleaning ingredient.

19. The cleaning packet of claim 18, wherein the paper pouch is composed of cellulose, lignin, hemicellulose, or carboxymethylcellulose

20. The cleaning packet of claim 18, wherein the ink is an anti-microbial compound, an anti-odor compound, a dye, a fragrance, a surfactant, or a redeposition inhibitor.

21. A method of washing a load of fabric using a cleaning packet, comprising:
providing the cleaning packet to a washing machine containing the load of fabric, wherein the cleaning packet includes a detergent sealed in a pouch that is formed of a paper material that is at least partially water-soluble, and wherein the cleaning packet further includes a message or graphic printed on the paper pouch with an ink containing an active ingredient;
operating the washing machine to allow the cleaning packet to come in contact with water;
releasing the active ingredient of the ink of the message or graphic printed on the paper material into water, upon contact of the cleaning packet with water; and
at least partially degrading the paper material to release the detergent contained within the pouch into the water;
wherein the degradation of the paper material is initiated after the release of the active ingredient of the ink of the cleaning packet.

22. The method of claim 21, wherein the paper pouch is composed of cellulose, lignin, hemicellulose, or carboxymethylcellulose.

23. The method of claim 21, wherein the active ingredient of the ink includes a dye, fragrance, surfactant, redeposition inhibitor, anti-microbial compound, or anti-odor compound.
